(19) United States
(12) Patent Application Publication
(10) Pub. No.: US 2005/0034306 A1
(43) Pub. Date: Feb. 17, 2005

(54) Method for producing a sectionally-reinforced tubular member of metal, in particular for supporting structures in motor vehicles

(76) Inventors: Lothar Patberg, Aachen (DE); Uwe Kneiphoff, Dinslaken (DE)

Correspondence Address: PROSKAUER ROSE LLP;PATENT DEPARTMENT, 1585 BROADWAY, NEW YORK, NY, 10036-8299, US

(21) Appl. No.: 10/881,809

(22) Filed: Jun. 30, 2004

(30) Foreign Application Priority Data
Jul. 24, 2003 (DE) 103 33 678.8-14

(51) Int. Cl. B32B 31/00

(52) U.S. Cl. 29/897; 156/293

(57) ABSTRACT

The invention relates to a method for manufacturing a sectionally reinforced member made of a tubular hollow profile (1) made of metal. For sectional reinforcement of the hollow profile (1), a sleeve (3) made of metal is slid onto the hollow profile (1) and on the entire area of the section to be reinforced is bonded with bonding agent (2), so that the wall of the tubular hollow section (1) and the sleeve (3) as a result of the bonding agent (2) form a bond. In order to facilitate sliding the sleeve (3) onto the hollow profile (1), the sleeve (3) is enlarged by heating, and/or the external dimensions of the hollow section (1) are reduced by cooling. Forming the hollow section (1) comprising the sleeve (3) into a member takes place prior to a finishing additional treatment step for the purpose of curing the bonding agent (2).

In motor vehicle construction, for reasons of lightweight build, there is an increased use of cold-formed tubular members made of metal, in particular of steel, in the manufacture of supporting structures as supporting and crash-absorbing components. Such members, which have been optimised in relation to their weight and loads, comprise some sections along the length of the member in which sections dimensioning of the wall thickness and/or the materials is different. Such members are made from special sheet metal plates, so-called “tailored blanks” in which the different sections are produced by rolling, or by welding together different sheet metal sections. Subsequently, such a plate is deformed to form a longitudinally-slit tube and is longitudinally seam-welded.

Manufacturing such tailored tubes produced by rolling and/or welding, which tubes comprise different wall thicknesses along their lengths, is expensive. Therefore, alternative solutions are sought for producing weigh-optimised and load-optimised tubular members as components for supporting structures in motor vehicles, with the production of such members being less expensive. Furthermore, such members are to be cold formable.

In a known method for producing tubular hollow profiles, a strengthener element and/or functional element is joined locally at the wall of the hollow profile (DE 100 38 337 A1). The manufacture of such a hollow profile which comprises a strengthener element takes place in such a way that the strengthener element is placed on a still flat sheet metal plate and is deformed together with said sheet metal plate to form a longitudinally-slit tube which is then longitudinally seam-welded. In this known method it is not provided, and it is practically also not possible, for the strengthener element to extend around the entire circumference of the tube. The strengthener effect is thus limited to smaller regions of the circumference of the tubular hollow profile.

In another known method for producing a deformable, preformed, thin-walled semifinished product made of sheet metal, in particular a tubular hollow profile (DE 197 37 969 A1) a sheet metal reinforcing piece which matches the external contours of the tubular hollow profile is bonded, soldered, welded or riveted to the tubular hollow profile. This type of attachment of the preformed sheet metal reinforcing piece poses no problems since, unlike a sleeve, it only extends around part of the circumference of the tubular hollow product. In this state of the art, the problems of mutual further deformation of the tubular hollow profile which has been complemented with the sheet metal reinforcing piece are not discussed.

Finally, a method for shrinking a metal envelope onto a tubular hollow product is known (DE 27 28 441 A1). The method commonly used to this effect, namely to heat the envelope above the ambient temperature so that said envelope expands and can be slid over the tubular hollow product, is described as difficult because the thin envelope holds very little heat and easily cools down and shrinks even before it has been completely drawn over the die. It is therefore proposed that the envelope be bent from sheet metal plate that has been placed around the die, with the overlapping edges of said sheet metal plate being welded together. However, this is associated with a disadvantage in that such a sectional reinforcement is not round. As a solution to this collection of problems it has finally been proposed to butt-weld a sheet metal plate which has been bent to form an envelope at its adjoining edges, and to arrange blind weld seams distributed around its circumference, which cause the envelope to shrink around the circumference. However, such a method is expensive and causes inhomogeneities in the area of the weld seams. It is also questionable whether such a reinforced tubular hollow body can still be deformed.

Starting from the described state of the art, it is the object of the invention to produce a tubular member made of metal, in particular steel, which comprises at least one reinforced section which corresponds to a reinforced section known from tailored tubes.

In a method for manufacturing a sectionally reinforced tubular member, in particular a longitudinally seam-welded member, made of metal, in particular steel, on whose wall at least one sheet metal reinforcing piece is joined, this object is met by the following method-related steps:
a) At each section to be reinforced, the hollow profile comprises a layer of bonding agent which can be cured by additional treatment.
b) A sleeve made of metal, in particular steel, is slid onto the hollow profile up to the section to be reinforced after at least one of the two “connection partners”, namely the hollow profile and the sleeve, have been subjected to such heat treatment that sufficient play results between the hollow profile and the sleeve for the sleeve to be able to be slid on.
c) Finally, the bonding agent is cured by additional treatment of the hollow profile in the region of the sleeve.

Producing the sectionally reinforced member according to the invention is very easy. The starting point is provided by a conventional tubular hollow profile which at the section or sections to be reinforced, depending on future loads encountered during operation, is fitted with a sleeve which forms an integral bond with the tube wall. Possible variations in materials selection and in the wall thickness of the sleeve provide a multitude of combination options for optimally adapting this connection to future loads encountered during operation. If the hollow profile still has to be formed to a member, e.g. if it has to be bent or otherwise profiled by means of internal high-pressure forming, this is easily possible if such forming takes place before final curing of the bonding agent, i.e. in a phase in which the integral bond has not yet been achieved on the section to be reinforced. Prior to curing, the bonding agent is sufficiently elastic to partake in the forming of the hollow profile and the sleeve. The type of additional treatment of the bonding agent depends on the materials composition of the bonding agent. Preferably, a bonding agent is used which cures by thermal treatment at an increased temperature.

According to one embodiment of the invention, a sleeve should be used which in the cold state has overmeasure vis-á-vis the hollow profile, which overmeasure is equal to the thickness of the layer of the bonding agent. This ensures that sufficient bonding agent is available for an integral bond over the entire area.

Easy sliding on of the sleeve is made possible by heat treatment which can take place by heating the sleeve and/or cooling the hollow profile. Preferably, prior to the sleeve being slid on, the hollow profile is cooled to below room temperature. This has the additional advantage in that, if a viscous bonding agent is used, said viscous bonding agent becomes relatively stiff and cannot be scraped off in parts so easily when the sleeve is slid into place. If the sleeve is heated in addition and if a thermally-curing bonding agent is used, said sleeve should be kept below a temperature which corresponds to the reaction temperature of the bonding agent.

The bonding agent used can be a spray-on bonding agent or a film bonding agent.

If the hollow section in particular has to be cold-formed to become a member, but the slid-on sleeve has not yet been adequately fixed by the bonding agent, the sleeve can be fixed to the hollow section by additional means, for example it can be fastened by spot welding.

Below, the invention is explained in more detail by means of a drawing which shows one embodiment. The following are shown:

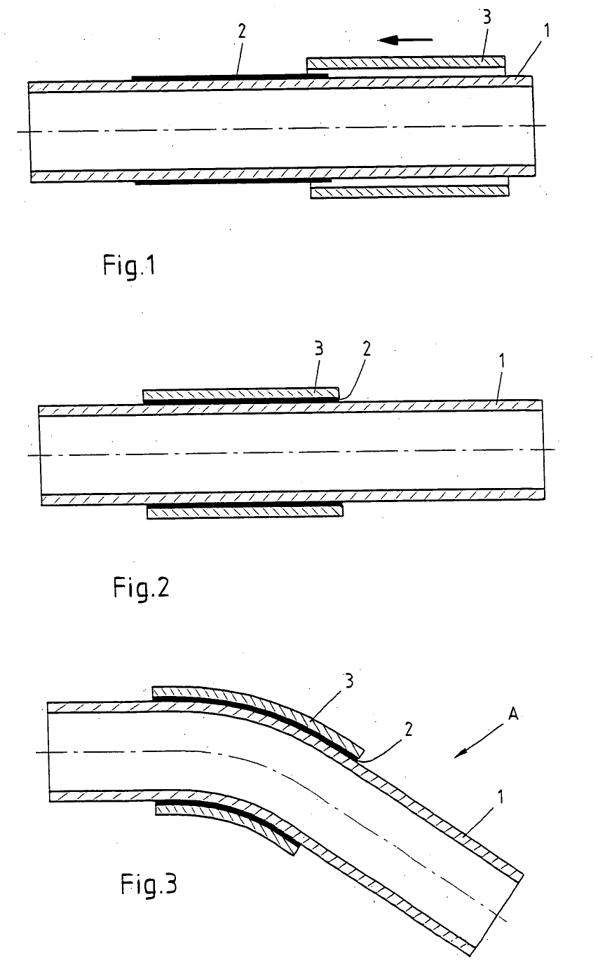

FIG. 1 an axial section of a tubular hollow section made from metal in the production phase of sliding a sleeve on;

FIG. 2 an axial section of the tubular hollow profile according to FIG. 1 with the sleeve placed onto the section to be reinforced; and

FIG. 3 an axial section of the tubular hollow section after cold forming (bending to become a member).

A tubular hollow profile 1 can be made from a sheet metal plate, in particular made from steel, by forming to become a longitudinally-slit hollow product and by subsequent longitudinal seam-welding. A slid-on sleeve 3 made of sheet metal, in particular of steel sheet metal, which sleeve 3 has been fixed by a layer of a bonding agent 2, serves to reinforce a section of such a hollow section 1. In order to place the sleeve 3 on the section to be reinforced, first a bonding agent 2 is applied to the outside of the hollow section 1. Said bonding agent 2 can be sprayed on, or an adhesive film can be applied. Any bonding agent is suitable which in the cold state provides adequate strength and elasticity and a lower bonding strength when compared to the normal temperature.

Since the sleeve 3 is to be seated on the hollow section 1 as far as possible with a positive fit along its entire length while nevertheless preventing the bonding agent 2 from being displaced, the sleeve 3 has a slight overmeasure in relation to the hollow section 1, with said overmeasure being the equivalent of the intended thickness of the layer of the bonding agent 2. In order to nevertheless make it easy for the sleeve 3 to be slid onto the hollow section 1, the external dimensions of the hollow section 1 are reduced by cooling, and/or the sleeve 3 is enlarged by heating. When a bonding agent 2 is used which becomes soft when it is heated, cooling the hollow section 1 has a positive side effect in that the bonding agent 2 remains firm and does not become adhesive. For the same reason, when the sleeve 3 is being heated, its temperature should be kept to below the curing temperature of the bonding agent 2. As soon as the slid-on sleeve 3 is placed in the section to be reinforced, the hollow profile 1 and the sleeve 3 can revert back to room temperature. At this temperature, the sleeve 3, while preserving the layer of bonding agent 2, is seated reasonably firmly on the hollow section 1. This state is shown in FIG. 2.

In order to bend to hollow section to form a member A, as shown in FIG. 3, as a rule the adhesive force of the bonding agent 2 and the firm seating of the sleeve 3 are not sufficient for fixing the sleeve 3 in the section to be reinforced. However, to enable easy bending or other deformation of the hollow profile 1 with the seated sleeve 3, the bonding agent 2 should not yet have been subjected to additional treatment for curing. In order to nevertheless axially fix the sleeve 3 on the hollow section 1, one edge of the sleeve 3 can be fastened to the hollow section 1 by means of at least one weld spot. Since the elastic bonding agent 2 practically does not impede deforming of the hollow profile to become a member A, and since one or even a few weld points also do not impede deforming, deforming is easily possible.

If the member is destined to become part of the supporting structure of a motor vehicle body, preferably incorporation of the member into the supporting structure takes place in the next step. Curing of the bonding agent 2 by means of additional treatment only takes place after this deforming step and if need be after incorporation into the supporting structure, with said additional treatment depending on the type of the bonding agent 2 used. As a rule, a bonding agent is used which cures as a result of the effect of heat. Since usually in the supporting structures of motor vehicles the members A also comprise a paint which is curable by the application of heat, the bonding agent and the paint can be cured in a common process step (KTL at approx. 180° C. (KTL=catholytic dipping lacquering)). The temperature applied in this process is then as a rule above the temperature necessary for curing the bonding agent.

1-10. (canceled)

11. A network for manufacturing a sectionally reinforced member made of a tubular, in particular longitudinally seam-welded, hollow profile made of metal, in particular steel, on whose wall at least one sheet metal reinforcing piece is joined, comprising the following method-related steps:
a) At each section to be reinforced, the hollow profile comprises a layer of bonding agent which can be cured by additional treatment.
b) As a sheet metal reinforcing piece, a sleeve made of metal, in particular steel, is slid onto the hollow profile over the section to be reinforced, after at least one of the two “connection partners”, namely the hollow profile and the sleeve, have been subjected to such heat treatment that sufficient play results between the hollow profile and the sleeve for the sleeve to be able to be slid on.
c) Finally, the bonding agent is cured by additional treatment of the hollow profile in the region of the sleeve.

12. The method according to claim 11, wherein the hollow profile is formed to become a member prior to the additional treatment used for curing the bonding agent.

13. The method according to claim 11, wherein a sleeve is used which in the cold state has overmeasure via-a-vis the hollow profile, which overmeasure is equal to the thickness of the layer of the bonding agent.

14. The method according to claim 11, wherein prior to the sleeve being slid on, the hollow profile is cooled to below room temperature.

15. The method according to claim 11, wherein the sleeve is slid on in its heated state.

16. The method according to claim 15, wherein if a thermally-curing bonding agent is used, the temperature of the heated sleeve is kept below the reaction temperature of the bonding agent.

17. The method according to claim 11, wherein a spray-on bonding agent is used.

18. The method according to claim 11, wherein a film bonding agent is used.

19. The method according to claim 11, wherein for forming the hollow section which comprises the sleeve, the sleeve is fixed to the hollow section by additional means.

20. The method according to claim 12, wherein when the hollow profile which has been formed to become a member is used in a supporting structure of a motor vehicle body, the member is built into the supporting structure, and then the entire supporting structure is subjected to an additional treatment which is also serves to cure the bonding agent.
